(19) United States
(12) Patent Application Publication
(10) Pub. No.: US 2011/0270655 A1
(43) Pub. Date: Nov. 3, 2011

(54) Offer conversion

(76) Inventors: Kemal Guler, San Jose, CA (US); Mehmet Oguz Sayal, Foster City, CA (US); Burcu Aydin, San Mateo, CA (US)

(21) Appl. No.: 12/770,675

(22) Filed: Apr. 29, 2010

(51) Int. Cl. G06Q 30/00; G06Q 10/00

(52) U.S. Cl. 705/14.13; 705/14.1

(57) ABSTRACT

A source offer and offer parameters regarding the source offer are received. Specifications for one or more of a number of conversion parameters are also received. The source offer is converted to a target offer, based on the offer parameters and the conversion parameters specified. Where the source offer is an incremental offer, the target offer is a cumulative offer. Where the source offer is a cumulative offer, the target offer is an incremental offer. In an incremental offer, when a volume reaches a volume threshold, a price decreases by a corresponding price discount for the volume above the volume threshold, but the price does not decrease for the volume below the volume threshold. In a cumulative offer, when the volume reaches at the volume threshold, the price decreases by the corresponding price discount for the volume both below and above the volume threshold.

### BACKGROUND

A common way for a party, such as a business or an individual, to purchase a product or a service is to solicit offers from multiple suppliers. Once the offers have been received, the party compares the offers to one another. The party then selects a supplier (or suppliers) from which to purchase the product or service. For example, the party may select the supplier (or suppliers) that are offering the lowest purchase price for the product or service, or the party may base its decision on additional or other considerations.

### BRIEF DESCRIPTION OF THE DRAWINGS

FIG. 1 is a flowchart of a method converting a source offer to a target offer, according to an embodiment of the present disclosure.

FIGS. 2A and 2B are graphs of representative incremental and cumulative offers, respectively, according to an embodiment of the present disclosure.

FIG. 3 is a graph of a representative target offer to which a source offer having offer parameters has been converted in accordance with example conversion parameters, according to an embodiment of the present disclosure.

FIG. 4 is a graph of an example source offer having a single corresponding example target where the price thresholds, the volume thresholds, and the number of steps of the conversion parameters have all been specified and in equal numbers, according to an embodiment of the present disclosure.

FIG. 5 is a graph of an example source offer having more than one corresponding example target offers where the price thresholds, the volume thresholds, and the number of steps of the conversion parameters have not all been specified, or have all been specified but in unequal numbers, according to an embodiment of the present disclosure.

FIG. 6 is a diagram of a representative computing device, according to an embodiment of the present disclosure.

### DETAILED DESCRIPTION

As noted in the background section, a party may purchase a product or service by soliciting offers from multiple suppliers, and comparing the offers to one another, and then selecting a supplier (or suppliers) from which to purchase the product or service. One problem with this approach is that the offers may be of different types. This makes it difficult for the offers to be directly compared to one another.

For example, a supplier may maintain an offer structure of a particular type that is used to respond to solicitations from prospective customers. When a prospective customer solicits offers from a number of suppliers, the customer may receive back offers of different types, making direct comparison between offers difficult. Alternatively, a prospective customer may solicit an offer from a particular supplier, and request that the supplier provide an offer of a specific type. However, the supplier may not normally provide offers of this type, and thus has to convert its standard type offer to the type being requested.

One type of offer is referred to herein as an incremental offer. An incremental offer includes a base price for an item, and one or more price discounts having one or more corresponding volume thresholds, such that there are equal numbers of price discounts and volume thresholds. When the party purchases a volume of the item that exceeds a given volume threshold, the base price is decreased for the volume of the item above the threshold by a corresponding price discount, but the base price is not decreased for the volume below the threshold.

For example, an incremental offer may be specified by a base price p, one or more price discounts d1, d2, d3, . . . , dk, and one or more volume thresholds t1, t2, t3, . . . , tk that correspond to the price discounts. If a party purchases a total of j items, where j is greater than t1 but less then t2, then for t1 items the unit price is p, and for (j−t1) items the unit price is (p−d1). Thus, the total cost for the j items is thus (t1×p)+(j−t1)(p−d1). Similarly, if the party purchases j items, where j is greater than t2 but less than t3, then for t1 items the unit price is p, for (t2−t1) items the unit price is (p−d1), and for (j−t2) items the unit price is (p−d2), depending on how the offer is specified. The total cost for the j items is thus (t1×p)+(t2−t1)(p−d1)+(j−t2)(p−d2).

It is noted that the price discounts may be positive or negative. In the case where a price discount is negative, it is effectively a surcharge or mark-up. For example, between zero and fifty units, a supplier may charge a base price of five dollars. Above fifty units, a supplier may specify a surcharge or mark-up of one dollar, such that the units sold in excess of fifty units cost six dollars each. In this case, the one-dollar surcharge or mark-up is considered a price discount of negative one dollar.

Another type of offer is referred to herein as a cumulative offer. A cumulative offer also includes a base price for an item, and one or more price discounts having one or more corresponding volume thresholds, such that there are equal numbers of price discounts and volume thresholds. When the party purchases a volume of the item that exceeds a given volume threshold, the base price for the entire volume is reduced by a corresponding price discount. That is, the base price for the volumes of the item both below and above the threshold is reduced by the price discount. As such, thresholds are used just to determine the unit price that applies to the whole purchase.

For example, a cumulative offer may also be specified by a base price p, one or more price discounts d1, d2, d3, . . . , dk, and one or more volume thresholds t1, t2, t3, . . . , tk that correspond to the price discounts. If a party purchases a total of j items, where j is greater than t1 but less then t2, then for all j items, the unit price is (p−d1), and the total cost for the j items is j×(p−d1). Similarly, if the party purchases j items, where j is greater than t2 but less than t3, then for all j items, the unit price is either or (p−d2), depending on how the offer is specified. The total case for the j items is thus j×(p−d2). As with incremental offers, cumulative offers may have price discounts that are positive or negative, where in the latter case, the price discounts are effectively price surcharges.

Embodiments of the present disclosure provide for converting an incremental offer to a corresponding cumulative offer, and for converting a cumulative offer to a corresponding incremental offer. As such, disparate types of offers that are received from different suppliers can be compared to one another. Those offers that are not cumulative offers may be converted to cumulative offers, so that all the offers can be compared to one another as cumulative offers. Alternatively, those offers that are not incremental offers may be converted to incremental offers, so that all the offers can be compared to one another as incremental offers.

To convert a cumulative offer to an incremental offer, and vice-versa, the source offer and a number of offer parameters regarding the source offer are received. The offer parameters effectively describe the source offer. Specifications for one or more of a number of conversion parameters are also received. The specified conversion parameters govern how the source offer will be converted to a target offer of other type. That is, the specified conversion parameters govern how an incremental source offer will be converted to a cumulative target offer, and how a cumulative source offer will be converted to an incremental target offer.

At least some embodiments of the disclosure permit not all the conversion parameters to be specified. In this situation, a given source offer can be converted to more than one different target offer. To convert the given source offer to just one target offer, a programming problem can be solved in which a given metric is minimized to find the best approximation target offer to the source offer. That is, the target offer that minimizes the metric is the target offer to which the given source offer is converted. In this way, these embodiments still convert a source offer to a single target offer, even when the specified conversion parameters permit the source offer to be converted to more than one target offer.

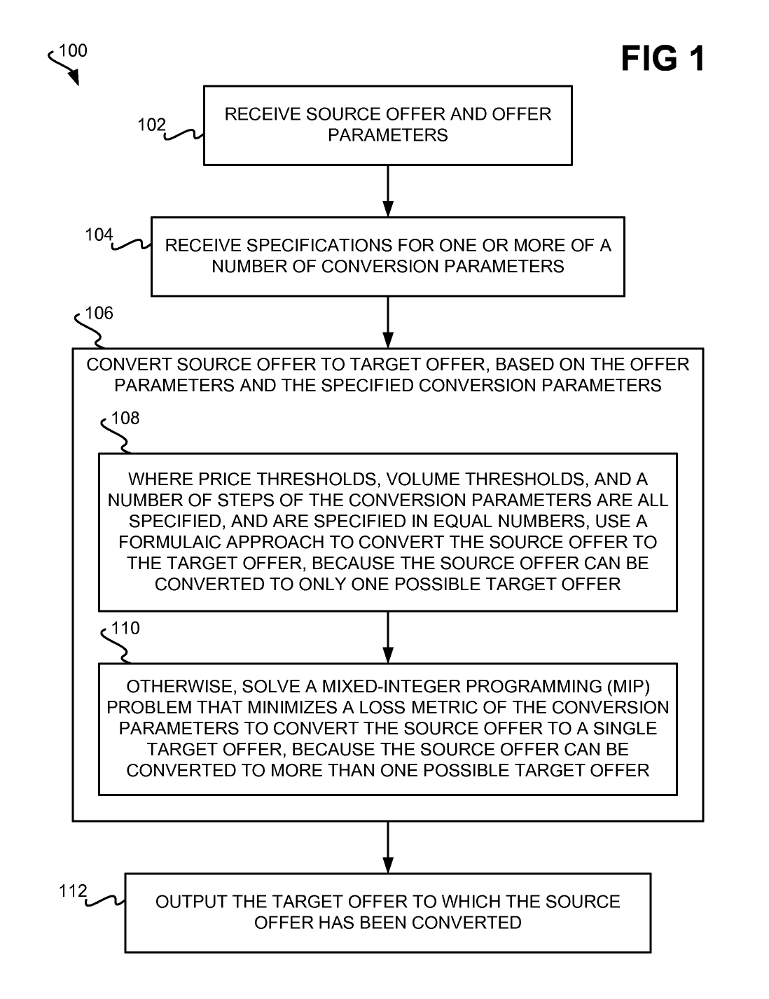

FIG. 1 shows a method 100 for converting a source offer to a target offer, according to an embodiment of the disclosure. The method 100 may be implemented by one or more computer programs stored on a computer-readable data storage medium, such as a hard disk drive, a semiconductor memory, or another type of computer-readable data storage medium. Execution of the computer programs by a processor of a computing device, like a desktop or a laptop computer, causes the method 100 to be performed. The method 100 converts an incremental offer to a cumulative offer, or a cumulative offer to an incremental offer.

The source offer, and offer parameters regarding the source offer, are received (102), such as from a user, who may be interacting with a graphical user interface. The offer parameters include a base price p, a number of price discounts d1, d2, d3, . . . , dk, and a corresponding number of volume thresholds t1, t2, t3, . . . , tk that indicate volumes at which the price discounts are to be applied. For an incremental offer, when a volume reaches a volume threshold, the unit price decreases by a corresponding discount for the volume above the volume threshold, but does not decrease for the volume below the volume threshold. By comparison, for a cumulative offer, when a volume reaches a volume threshold, the price decreases by the corresponding price discount for the volume both below and above a volume threshold.

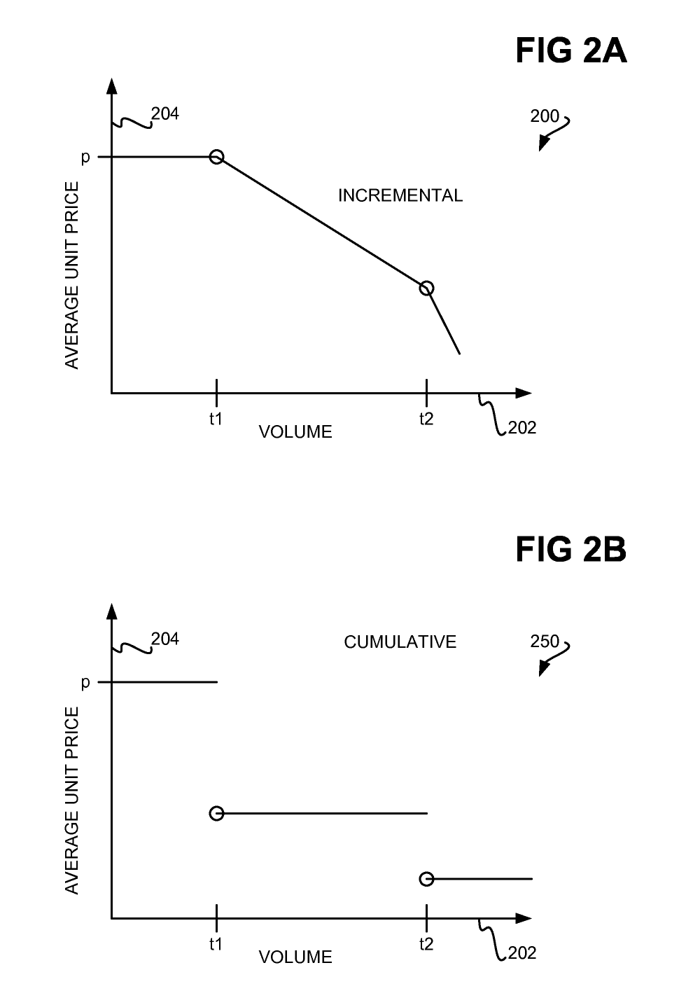

FIGS. 2A and 2B show graphs 200 and 250 of the average unit price within an incremental offer and within a cumulative offer, respectively, according to an embodiment of the disclosure. In both the graphs 200 and 250, the x-axis 202 denotes volume, whereas the y-axis 204 denotes average unit price. The graphs 200 and 250 presume an offer having offer parameters including a base price p, two price discounts d1 and d2, and two corresponding volume thresholds t1 and t2.

In the graph 200 of FIG. 2A for the incremental offer, for volumes v below the volume threshold t1, the average unit price is p, and the total price is v×p. For volumes v between the volume thresholds t1 and t2, the average unit price is

$$\frac{( v - t 1 ) \times ( p - d 1 ) + t 1 \times p}{v} ,$$

and the total price is (v−t1)×(p−d1)+t1×p. For volumes v above the volume threshold t2, the average unit price is

$$\frac{( v - t 2 ) \times ( p - d 2 ) + ( t 2 - t 1 ) ( p - d 1 ) + t 1 \times p}{v} ,$$

and the total price is (v−t2)×(p−d2)+(t2−t1)(p−d1)+t1×p.

In the graph 250 of FIG. 2B for the cumulative offer, for volumes v below the volume threshold t1, the average unit price is p, and the total price is v×p. For volumes v between the volume thresholds t1 and t2, the average unit price is p−d1, and the total price is v×(p−d1). For volumes v greater than the volume threshold t2, the average unit price is p−d2, and the total price is v×(p−d2).

Referring back to FIG. 1, specifications for one or more of a number of conversion parameters are also received (104), such as from a user, who may be interacting with a graphical user interface. The conversion parameters control how the source offer having the offer parameters is converted to a target offer. The conversion parameters include a number of price thresholds, a number of volume thresholds, a number of steps, and a loss metric. That one or more of the conversion parameters are specified means that not all four of the conversion parameters have to be specified. For example, a user may specify just one, two, or three of the conversion parameters, or the user may specify all four of the conversion parameters. How and which of the conversion parameters are specified dictate the number of possible target offers to which the source offer can be converted, as described in detail later in the detailed description.

Each price threshold indicates a price at which a price discount is to be applied in the target offer to which the source offer is to be converted. The price thresholds are specified as one or more price thresholds pt1, pt2, . . . , ptm, for m price thresholds, where m is the number of price thresholds specified and is greater than or equal to one, when the price thresholds are specified. Each volume threshold indicates a volume at which a price discount is to be applied in the target offer to which the source offer is to be converted. The volume thresholds are specified as one or more volume thresholds vt1, vt2, . . . , vtn, for n price thresholds, where n is the number of volume thresholds specified and is greater than or equal to one, when the volume thresholds are specified.

In one embodiment, the user may indicate whether a specified volume threshold corresponds to a specified price threshold. For example, if there are two price thresholds pt1 and pt2, and three volume thresholds vt1, vt2, and vt3, the user may indicate that the price threshold pt1 corresponds to the volume threshold vt1, and that the price threshold pt2 corresponds to the volume threshold vt3. In another embodiment, the user does not have to provide this information. In this case, the price threshold pt1 can correspond to either volume threshold vt1 or vt2, and the price threshold pt2 can correspond to either volume threshold vt2 or vt3.

For example, the price threshold pt1 may be optimally determined later in the method 300 to correspond to the volume threshold vt1, and the price threshold pt2 may be optimally determined at that time to correspond to the volume threshold vt2 or vt3. As another example, the price threshold pt1 may be optimally determined later in the method 300 to correspond to the volume threshold vt2, and the price threshold pt1 may be optimally determined at that time to correspond to the volume threshold vt3. As a third example, the user may indicate that the price threshold pt1 corresponds to the volume threshold vt1, but may not indicate to which volume threshold vt2 or vt3 the price threshold pt2 corresponds.

The number of specified volume thresholds n may be equal to or unequal to the number of specified price thresholds m. A step corresponds to a volume threshold at which a corresponding price discount is to be applied, such that the number of steps is the number of times the target offer specifies a volume threshold at which a corresponding price discount is to be applied. The number of steps is specified as s, where s is greater than or equal to one when the number of steps is specified. The specified number s of steps may be equal to or unequal to each of the number n of specified volume thresholds and the number m of specified price thresholds.

The price thresholds and the volume thresholds of the conversion parameters are the minimum such price thresholds and volume thresholds that are to be realized within the target offer. That is, there can be more price thresholds, and more volume thresholds, depending on the number of steps specified, or whether the number of steps is specified. For example, if a user specifies two price thresholds and three volume thresholds, but does not specify the number of steps, then there has to be at least three steps within the target offer, since three volume thresholds have been specified. Two of these steps correspond to the two price thresholds specified, and a third step corresponds to a price threshold that is not specified. This price threshold is determined later in the method 300. The third step is included within the target offer because three volume thresholds have been specified. As another example, if a user specifies two volume thresholds, but does not specify any price thresholds and does not specify the number of steps, then there has to be at least two steps within the target offer, because two volume thresholds have been specified. Two of these steps correspond to the two volume thresholds specified.

Likewise, the number of steps is the minimum number of steps that are to be realized within the target offer, depending on the number of price thresholds and/or the number of volume thresholds specified, or whether the price thresholds and/or the volume thresholds are specified. In one embodiment, the actual number of steps within the target offer is the maximum of the number of steps specified when this number is specified, the number of volume thresholds specified when these thresholds are specified, and the number of price thresholds specified when these thresholds are specified. In another embodiment, the number of steps specified, when this number is specified, is the actual number of steps within the target offer. However, in this embodiment, the user is not permitted to enter a number of steps that is less than the maximum of the number of volume thresholds specified when these thresholds are specified, and the number of price thresholds specified when these thresholds are specified.

For example, if a user specifies four steps but specifies five price thresholds and does not specify any volume thresholds, then there has to be at least five steps within the target offer, since five price thresholds have been specified. As another example, if a user specifies four steps, five price thresholds, and six volume thresholds, then there has to be at least six steps within the target offer, since six volume thresholds have been specified. As a third example, if a user specifies four steps but does not specify any price thresholds or volume thresholds, then there has to be at least four steps within the target offer, since four steps have been specified.

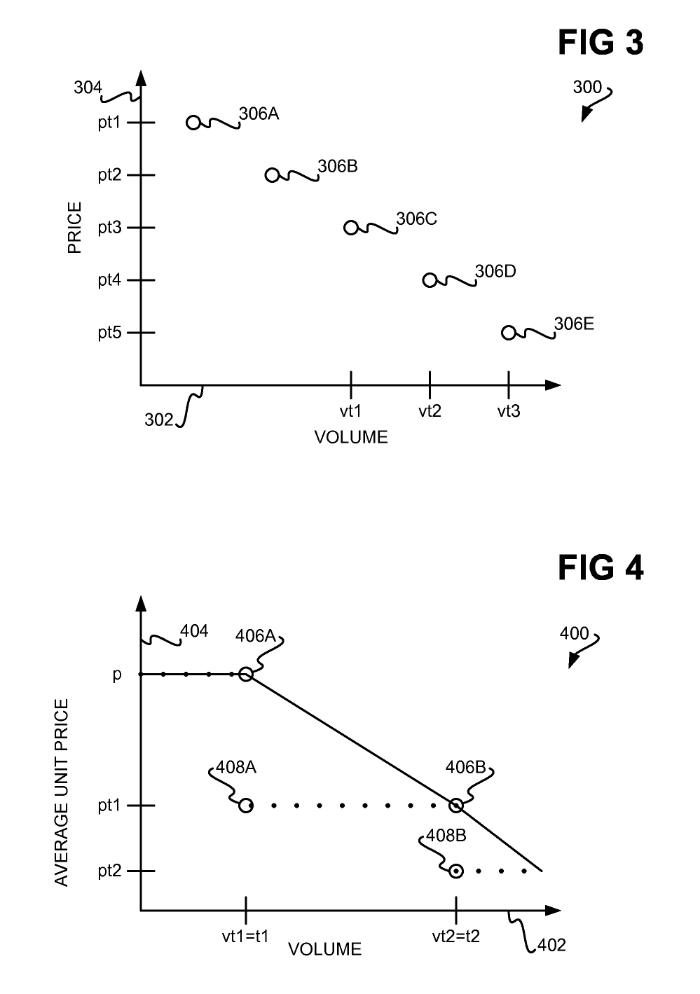

FIG. 3 shows a diagram of a graph 300 of a representative target offer to which a source offer having offer parameters has been converted in accordance with example conversion parameters, according to an embodiment of the disclosure. The x-axis 302 denotes volume, whereas the y-axis 304 denotes price. The example conversion parameters include five price thresholds pt1, pt2, pt3, pt4, and pts; three volume thresholds vt1, vt2, and vt3; and s=2 steps.

In the representative target offer FIG. 3, steps 306A, 306B, 306C, 306D, and 306E, collectively referred to as the steps 306, are represented by circles. There are five steps 306 in the representative target offer. The steps 306 correspond to volume thresholds, indicating that there are five volumes within the representative target offer at which a corresponding price discount is to be applied. Note, however, that just two steps have been specified within the conversion parameters, and that just three volume thresholds have been specified within the conversion parameters. Nevertheless, there are five total steps 306 within the target offer, because five price thresholds have been specified within the conversion parameters.

In the representative target offer, each of the specified price thresholds pt1, pt2, pt3, pt4, and pt5 corresponds to one of the steps 306. Furthermore, the specified volume threshold vt1 corresponds to the specified price threshold pt3 and to the step 306C. The specified volume threshold vt2 corresponds to the specified price threshold pt4 and to the step 306D. The specified volume threshold vt3 corresponds to the specified price threshold pt5 and to the step 306E. It is noted that in target offers to which the source offer in question has been converted, other than the representative target offer of FIG. 3, the each of the volume thresholds vt1, vt2, and vt3 may correspond to a different step 306 than that depicted in FIG. 3.

In the representative target offer, there are also volume thresholds corresponding to the steps 306A and 306B, and thus to the specified price thresholds pt1 and pt2. However, these volume thresholds are not specified volume thresholds. That is, these two volume thresholds were not specified within the conversion parameters. Rather, these two volume thresholds are determined in the process of converting the source offer in question to the representative target offer of FIG. 3. It is known a priori that there will be at least two such volume thresholds, in addition to the three specified volume thresholds vt1, vt2, and vt3, because five price thresholds have been specified within the conversion parameters. However, the volumes to which these volume thresholds correspond are not known a priori, but rather are determined in the process of converting the source offer in question to the representative target offer.

Referring back to FIG. 1, the source offer having the offer parameters received in part 102 is converted to one target offer, based on these offer parameters, as well as on the conversion parameters that were specified in part 104 (106). Where the source offer is an incremental offer, the target offer is a cumulative offer. Where the source offer is a cumulative offer, the target offer is an incremental offer.

Where the price thresholds, the volume thresholds, and the number of steps of the conversion parameters are all specified, and are all specified in equal numbers, then a formulaic approach is used to convert the source offer to the target offer (108). This is because the source offer can be converted to only one possible offer. That is, where the price thresholds, the volume thresholds, and the number of steps are all specified, and the number m of specified price thresholds is equal to the number n of specified volume thresholds and is equal to the specified number s of steps, then the source offer can be converted to only one possible target offer. As such, a formulaic approach can be used to convert the source offer to the only possible target offer. The formulaic approach may be a conventional straightforward algebraic approach, for instance.

FIG. 4 shows a graph 400 depicting an example of this case, in which an example source offer can be converted to only one possible target offer due to the price thresholds, volume thresholds, and number of steps all being specified in equal numbers, according to an embodiment of the disclosure. The x-axis 402 denotes volume, whereas the y-axis 404 denotes average unit price. The example source offer is an incremental source offer that specifies a base price p, two price discounts d1 and d2, and two corresponding volume thresholds t1 and t2. The conversion parameters include two price thresholds pt1 and pt2, two volume thresholds vt1 and vt2, and that there are to be s=2 steps.

The solid line in the graph 400 represents the example source offer. The dotted lines in the graph 400 represent the only possible cumulative target offer to which this example source offer can be converted. Specifically, the specified volume threshold vt1 of the target offer is equal to the volume threshold t1 of the source offer, and the specified volume threshold vt2 of the target offer is equal to the volume threshold t2 of the source offer. The specified price threshold pt1 corresponds to the volume threshold vt1, and the specified price threshold pt2 corresponds to the volume threshold vt2.

There are two steps 406A and 406B, collectively referred to as the steps 406, in the source offer. The steps 406 correspond to the volume thresholds t1 and t2 of the source offer. There are also two steps 408A and 408B, collectively referred to as the steps 408, in the target offer. The step 408A corresponds to the specified price threshold pt1 and the specified volume threshold vt1 of the target offer, whereas the step 408B corresponds to the specified price threshold pt2 and the specified volume threshold vt2 of the target offer.

Referring back to FIG. 1, in all other cases of specified conversion parameters, as compared to the case of part 108 as exemplified by FIG. 4, the source offer can be converted to more than one possible target offer, so a mixed-integer programming (MIP) problem is solved to minimize a loss metric of the conversion parameters to convert the source offer to a single target offer (110). The loss metric is one of the conversion parameters. The loss metric can be specified in part 104. If the loss metric is not specified in part 104, then a default loss metric is presumed.

Different types of loss metrics may be employed. One example loss metric is the maximum Manhattan distance between a unit price line of the source offer and a unit price line of the target offer. Another example loss metric is the average unit price difference between the source offer and the target offer. In general, the loss metric may be selected so that it represents the greatest likeliness of the source offer to the target offer that is determined when the loss metric is minimized.

Therefore, the MIP problem is solved to minimize the specified loss metric, or the default loss metric if no loss metric is specified, subject to the other specified conversion parameters, and given the offer parameters of the source offer. Commercially available solver software, another type of conventional solver, or another type of solver, may be used to solve the MIP problem in part 110. Alternatively, algorithmic solutions can be developed for each unique combination of which of these conversion parameters are specified. Therefore, depending on which conversion parameters are specified, a different algorithm can be employed to effectively and essentially solve the MIP problem in part 110.

As noted above, there is just one possible target offer for a source offer where the price thresholds, the volume thresholds, and the number of steps of the conversion parameters are all specified in equal numbers, and there is more than one possible target offer for the source offer in all other cases. One such case is where the price thresholds, the volume thresholds, and the number of steps are all specified, but in unequal numbers. For example, the number of specified price thresholds may be unequal to the number of specified volume thresholds, and/or to the specified number of steps.

A second such case is where the price thresholds and the volume thresholds are specified, but the number of steps is not specified. A third case is where the price thresholds and the number of steps are specified, but the volume thresholds are not, and a fourth case is where the volume thresholds and the number of steps are specified, but the price thresholds are not. A fifth case is where just the price thresholds are specified, and the number of steps and the volume thresholds are not. A sixth case is where just the volume thresholds are specified, and the number of steps and the price thresholds are not. A seventh such case is where just the number of steps is specified, and the price thresholds and the volume thresholds are not specified.

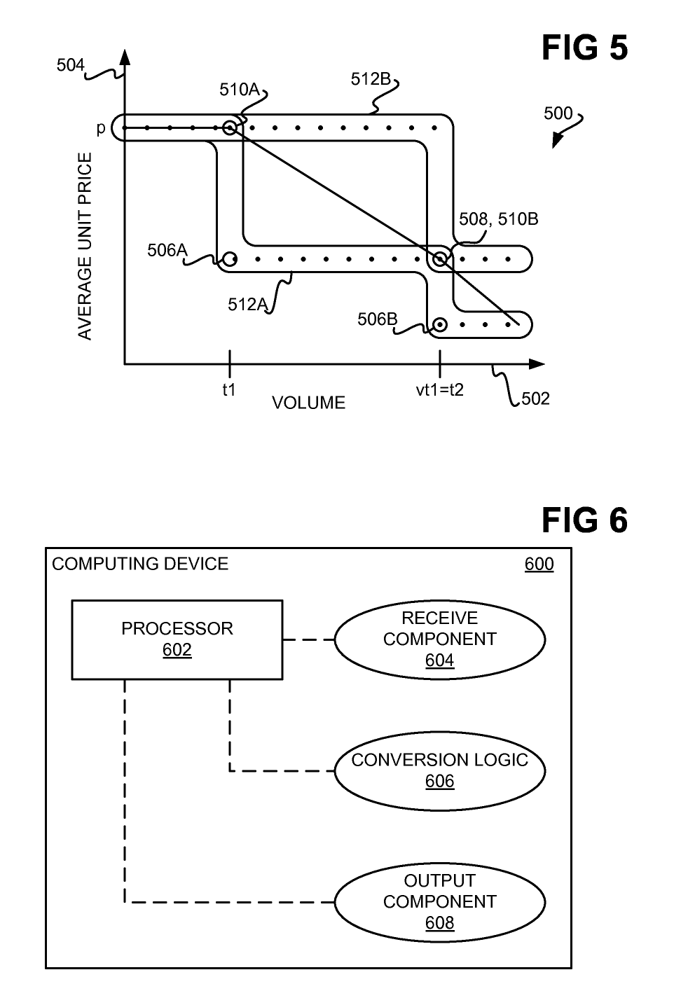

FIG. 5 shows a graph 500 depicting an example of one these cases, in which an example source offer can be converted to more than one possible target offer, according to an embodiment of the disclosure. Specifically, the graph 500 depicts an example of the sixth case, in which just the volume thresholds of the conversion parameters are specified, and the number of steps and the price thresholds are not specified. The x-axis 502 denotes volume, whereas the y-axis 504 denotes average unit price. The example source offer is an incremental source offer that specifies a base price p, two price discounts d1 and d2, and two corresponding volume thresholds t1 and t2. The conversion parameters include one volume threshold and no price thresholds, and also do not specify any number of steps.

The solid line in the graph 500 represents the example source offer. The dotted lines in the graph 500 represent two possible cumulative target offers 512A and 5128, collectively referred to as the cumulative target offers 512, to which this example source offer can be converted. There are other cumulative target offers to which the example source offer can be converted, however. In both of the example target offers 512, the specified volume threshold vt1 is equal to the volume threshold t2 of the source offer. In the example target offer 512A, there is another volume threshold, which is unspecified in the conversion parameters, and that is equal to the volume threshold t1 of the source offer. In the other example target offer 512B, there is no volume threshold other than the specified volume threshold vt1.

There are two steps 510A and 510B, collectively referred to as the steps 510, in the source offer. The steps 510 correspond to the volume thresholds t1 and t2 of the source offer. In the two example target offer 512A, there are also two steps 506A and 506B, collectively referred to as the steps 506. The step 506B corresponds to the specified volume threshold vt1 of the conversion parameters, whereas the step 506A does not correspond to a specified volume threshold of the conversion parameters. In the other example target offer 512B, there is just one step 508, which corresponds to the specified volume threshold vt1 of the conversion parameters.

Therefore, the example target offer 512A, from left to right in FIG. 5, descends at the volume threshold t1 to the step 506A, and then extends to the volume threshold vt1, where this target offer descends to the step 506B. By comparison, the example target offer 512B, from left to right in FIG. 5, descends at the volume threshold vt1 to the step 508. There are thus two steps 506 in the example target offer 512A, whereas there is just one step 508 in the example target offer 512B.

FIG. 5 thus illustrates how a source offer can correspond to more than one possible target offer where the price thresholds, the volume thresholds, and the number of steps are specified in the conversion parameters in equal numbers. Specifically, FIG. 5 illustrates the case where just the volume thresholds are specified, particularly a single volume threshold vt1. In the example of FIG. 5, the specified volume threshold vt1 need not be the only volume threshold of the target offer, but has to be one of the volume thresholds of the target offer. As such, the example target offer 512A includes two volume thresholds, including the specified volume threshold vt1, whereas the example target offer 512B includes just the specified volume threshold vt1. One of the possible target offers to which the example source offer can be converted, given the conversion parameters, is selected as the single target offer to which this source offer is converted, by solving a MIP programming problem that minimizes a loss metric, as noted above.

Referring back to FIG. 1, the single target offer to which the source offer has been converted in part 106 is output (112). For example, the target offer may be displayed on a display device for viewing by a user, the target offer may be stored on a computer-readable data storage device for further processing, and/or the target offer may be communicated over a network, among other types of output. The target offer may be output so that it can be compared to offers from other suppliers, where the target offer corresponds to a source offer from a given supplier.

In this case, the offers can be compared on the basis of being the same type, even though the offers as originally received from the suppliers may not have been of the same type. For example, if some suppliers submitted incremental offers and other suppliers submitted cumulative offers, the incremental offers can be converted to cumulative offers so that they can be more easily compared to the cumulative offers submitted by the other suppliers. Similarly, if some suppliers submitted cumulative offers and other suppliers submitted incremental offers, the cumulative offers can be converted to incremental offers so that they can be more easily compared to the incremental offers submitted by the other suppliers.

In conclusion, FIG. 6 shows a representative computing device 600, according to an embodiment of the disclosure. The computing device 600 includes a processor 602. The computing device 600 may and typically does include other hardware, in addition to the processor 602. For instance, the computing device 600 may include one or more computer-readable data storage media, such as a hard disk drive, semiconductor memory, and other types of computer-readable data storage media.

The computing device 600 includes a receive component 604, conversion logic 606, and an output component 608, all of which are said to be implemented by the processor 602, which is indicated by dotted lines in FIG. 6. For example, the components 604 and 608 and the logic 606 may each be or include one or more computer programs. As such, the components 604 and 608 and the logic 606 are implemented by the processor 602, insofar as the processor 602 executes these computer programs to realize the respective functionality of the components 604 and 608 and the logic 606.

The input component 604 receives a source offer, offer parameters regarding the source offer, and specifications for one or more of a number of conversion parameters. For example, the component 604 may be or realize a graphical user interface, by which this information is provided to the component 604 by a user using an input device that is part of or that is connected to the computing device 600. The input component 604 can thus be considered as performing parts 102 and 104 of the method 100 of FIG. 1.

The conversion logic 606 converts the source offer to a target offer, based on the offer parameters and the specific conversion parameters. Where the source offer can be converted to just one target offer, a formulaic approach, such as an algebraic approach, can be employed, as has been noted in relation to part 108 of the method 100 of FIG. 1. Where the source offer can be converted to more than one target approach, a MIP problem is solved to select one of these target approaches, as has been noted in relation to part 110 of the method 100. As such, the logic 606 can be considered as performing parts 106, 108, and 110 of the method 100.

The output component 608 outputs the target offer to which the source offer has been converted by the conversion logic 606 based on the offer parameters and the specified conversion parameters. For example, the component 608 may be or realize a graphical user interface as well, by which this information is provided to a user via an output device that is part of or that is connected to the computing device 600. The output component 608 can thus be considered as performing part 112 of the method 100 of FIG. 1.

We claim:

1. A method comprising:
receiving a source offer and a plurality of offer parameters regarding the source offer;
receiving specifications for one or more of a plurality of conversion parameters; and,
converting the source offer to a target offer, by a computing device, based on the offer parameters and the conversion parameters specified;
wherein where the source offer is an incremental offer, the target offer is a cumulative offer, and where the source offer is a cumulative offer, the target offer is an incremental offer,
wherein in an incremental offer, when a volume reaches a volume threshold, a price decreases by a corresponding price discount for the volume above the volume threshold, but the price does not decrease for the volume below the volume threshold,
and wherein in a cumulative offer, when the volume reaches at the volume threshold, the price decreases by the corresponding price discount for the volume both below and above the volume threshold.

2. The method of claim 1, wherein the offer parameters comprise a base price, one or more price discounts, and one or more volume thresholds indicating volumes at which the price discounts are to be applied.

3. The method of claim 1, wherein the conversion parameters comprise:
one or more price thresholds, each price threshold indicating a price at which a price discount is to be applied;
one or more volume thresholds, each volume threshold indicating a volume at which a price discount is to be applied; and,
a number of steps, each step corresponding to a volume threshold at which a price discount is to be applied.

4. The method of claim 3, wherein where the price thresholds, the volume thresholds, and the steps are all specified and in equal numbers,
each price threshold corresponds to one of the volume thresholds and to one of the steps, and the source offer can be converted to only one possible target offer.

5. The method of claim 3, wherein where the price thresholds, the volume thresholds, and the steps are all specified but in unequal numbers,
the source offer can be converted to more than one possible target offer.

6. The method of claim 3, wherein where the price thresholds and the volume thresholds are specified, but where the number of steps is not specified,
the source offer can be converted to more than one possible target offer.

7. The method of claim 3, wherein where the price thresholds and the number of steps are specified, but where the volume thresholds are not specified,
the source offer can be converted to more than one possible target offer.

8. The method of claim 3, wherein where the volume thresholds and the number of steps are specified, but where the price thresholds are not specified,
the source offer can be converted to more than one possible target offer.

9. The method of claim 3, wherein where the price thresholds are specified, but where the volume thresholds and the number of steps are not specified,
the source offer can be converted to more than one possible target offer.

10. The method of claim 3, wherein where the volume thresholds are specified, but where the price thresholds and the number of steps are not specified,
the source offer can be converted to more than one possible target offer.

11. The method of claim 3, wherein where the number of steps is specified, but where the price thresholds and the volume thresholds are not specified,
the source offer can be converted to more than one possible target offer.

12. The method of claim 3, wherein where the source offer can be converted to more than one possible target offer due to how the conversion parameters are specified, the conversion parameters further comprise a loss metric to be minimized when converting the source offer such that the source offer is converted to a single target offer by the computing device.

13. The method of claim 12, wherein converting the source offer to the single target offer comprises solving a mixed-integer programming (MIP) problem, by the computing device, in a manner that minimizes the loss metric.

14. A computing device comprising:
a processor;
a component implemented by the processor to receive a source offer, one or more offer parameters regarding the source offer, and specifications for one or more of a plurality of conversion parameters; and,
logic implemented by the processor to convert the source offer to a target offer, based on the offer parameters and the conversion parameters,
wherein where the source offer is an incremental offer, the target offer is a cumulative offer, and where the source offer is a cumulative offer, the target offer is an incremental offer,
wherein in an incremental offer, when a volume reaches a volume threshold, a price decreases by a corresponding price discount for the volume above the volume threshold, but the price does not decrease for the volume below the volume threshold,
and wherein in a cumulative offer, when the volume reaches at the volume threshold, the price decreases by the corresponding price discount for the volume both below and above the volume threshold.

15. A computer-readable data storage medium having one or more computer programs executable by a processor of a computing device, such that execution of the computer programs by the processor causes a method to be performed, the method comprising:
receiving a source offer and a plurality of offer parameters regarding the source offer;
receiving specifications for one or more of a plurality of conversion parameters; and,
converting the source offer to a target offer, based on the offer parameters and the conversion parameters specified;
wherein where the source offer is an incremental offer, the target offer is a cumulative offer, and where the source offer is a cumulative offer, the target offer is an incremental offer,
wherein in an incremental offer, when a volume reaches a volume threshold, a price decreases by a corresponding price discount for the volume above the volume threshold, but the price does not decrease for the volume below the volume threshold,
and wherein in a cumulative offer, when the volume reaches at the volume threshold, the price decreases by the corresponding price discount for the volume both below and above the volume threshold.
